(19) United States
(12) Patent Application Publication
(10) Pub. No.: US 2010/0098488 A1
(43) Pub. Date: Apr. 22, 2010

(54) Solar Powered Road Marker Light

(76) Inventors: Lennox M. Huck, Ningbo (CN); F. Chad Copier, Highland, UT (US); Alan Q. Parkinson, Sandy, UT (US)

Correspondence Address: Casey B. Harris;Patent Performance Co., PLLC, 7893 Weeping Ash Dr., Eagle Mountain, UT, 84005, US

(21) Appl. No.: 12/502,232

(22) Filed: Jul. 14, 2009

(30) Foreign Application Priority Data
Oct. 22, 2008 (NL) 1036102

(51) Int. Cl. B60R 21/16

(52) U.S. Cl. 404/14

(57) ABSTRACT

Embodiments of a solar powered road marker light disclosed that is self-powered and self-illuminating, producing high intensity illumination with relatively low energy consumption and which generates its own energy requirements in an environmentally friendly manner. The indicator is also quickly and easily installed on virtually any conventional road divider, marker, sign, traffic barrier, traffic control device, etc., and has low maintenance demands.

### FIELD

This patent application discloses a device related to road-side marking. More particularly, a solar powered road marker light using batteries, a printed circuit board (PCB), a photovoltaic cell (PV cell), and light-emitting diodes (LEDs).

### BACKGROUND

Road signs, markers, and reflectors play a vital role in maintaining road safety and reducing traffic accidents. Traffic road signs, markers, and reflectors generally consist of a reflective material, bearing the indicative sign or symbol, sandwiched or overlaid with a protective transparent overlay or cover. The signs and markers are generally clearly visible in the day by virtue of the bright contrasting colors of the reflective symbol. At night, on exposure to street lighting or vehicle headlights, the reflective material of the sign allows the symbol to be seen by road users.

One disadvantage with these signs and other reflectors is that the reflective material of the sign is prone to deterioration over time resulting in the gradual loss, to the reflective material, of its light reflective properties. In some instances, a driver may not have sufficient time to notice and react to a sign when driving at night since the visibility of the sign depends on illumination from the vehicle, requiring a driver to be somewhat close to a potentially hazardous road condition before becoming aware of the potentially dangerous condition.

Another disadvantage is that these signs and reflectors are not self-illuminating, relying purely on incident light. In areas without street lighting or when driving a vehicle with poor headlight quality, such signs are not easily seen and an accident can easily ensue. For example, signs can be difficult to read in the darkness and may be missed altogether in a vehicle that is damaged or temporarily functioning with less than all illumination.

### SUMMARY

Embodiments of a solar powered road marker light disclosed herein overcome the shortcomings of the prior art in that it is self-illuminating, producing high intensity illumination with relatively low energy consumption and which generates its own energy requirements in an environmentally friendly manner. The indicator is also quickly and easily installed on virtually any conventional road divider, marker, sign, traffic barrier, traffic control device, etc., and has low maintenance demands.

As used in this application, the term “indicator” may include a sign or other device that conveys a meaning or warning. The indicator device of the invention may be a barrier or obstruction indicator, and more specifically a road barrier or road obstruction indicator. Any road barrier, guard rail, marker, post, or road obstruction may be collectively referred to as a barrier. The indicator device may include a mounting plate with an inner surface adjacent or facing a barrier to which the device is attached, and an outer surface, a housing attached to the plate, a rechargeable energy store located within the housing, a photovoltaic (PV) module mounted to the outer surface of the marker, optimally located to harvest sunlight, and a light source which is energized by the rechargeable energy store, powered in turn by solar radiation captured by the photovoltaic module, to illuminate and thereby to warn motorists of the existence of the barrier, and a controller to regulate the energy harvest, energy store, and light source. The energy store may be one or more batteries or capacitors.

The plate may be shaped complementarily to a typical corrugated road barrier, to have a double corrugation configuration with a first corrugation, a second corrugation and a recess formed in between. The housing may be located within the recess, and the solar panel may be located on the first corrugation which forms the operatively upper end of the plate.

In other embodiments, the housing may be generally rectangular and the plate may be any number of configurations to connect the marker with various types of barriers including poles, cones, barrels, concrete (Jersey) barriers, walls, guard rails, guide posts, fences, trees, or any other barrier or object adjacent a roadway or intersection.

In some embodiments, the housing may be formed to correspond to the shape of a barrier, and the plate may be shaped to attach to hardware used to secure the portions of the barrier to each other. For example, the plate may be flat with a keyhole shaped opening. A connecting bolt on the barrier may be loosened enough to allow the keyhole opening to be placed over the bolt head and positioned such that when the bolt is retightened the plate, and thereby the marker, is attached to the barrier.

The light source may be located on a side wall or other surface of the housing. The light source may be at least one LED.

The indicator device may include an attachment portion for attaching the indicator to the road barrier. The attachment portion may be centrally located on the mounting plate.

The attachment means may be a nut and a bolt or other fastener.

The device may include a bolt channel which passes from the outer side of the plate through the housing, to the inner side to guide the bolt through the device to locate in a hole in the barrier which is in register with the channel. Alternatively or additionally, the attachment may be performed using an adhesive or magnetic strip, placed on the inner side of the plate to facilitate adherence of the indicator to the barrier.

The adhesive strip is a shock absorbent strip such as, for example, a rubber strip.

The device may include a reflective material. The material may be placed on a side wall or other surface of the housing to surround the light source and to enhance the general visibility of the indicator.

### BRIEF DESCRIPTION OF THE DRAWINGS

The following description can be better understood in light of Figures, in which:

FIG. 1 illustrates an embodiment of a marker light;

FIG. 2a illustrates an embodiment of a marker light;

FIG. 2b illustrates an embodiment of a marker light;

FIGS. 3a and 3b illustrates an embodiment of a marker light;

FIG. 4 illustrates an embodiment of a marker light;

FIGS. 5a and 5b illustrate an embodiment of a marker light; and

FIGS. 6a-6d illustrate an embodiment of a marker light.

Together with the following description, the Figures demonstrate and explain the principles of marker lights. In the Figures, the thickness and configuration of components may be exaggerated for clarity. The same reference numerals in different Figures represent the same component.

### DETAILED DESCRIPTION

Aspects and features of marker lights are disclosed and described below.

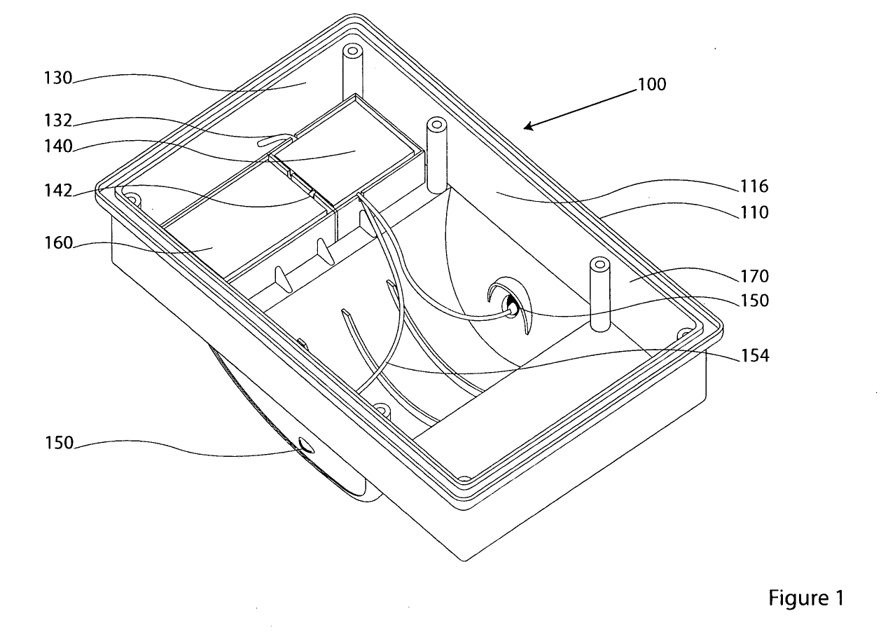

FIG. 1 illustrates marker light 100 with housing 110 holding PV module 130, controller 140, lights 150, and batteries 160. Housing 110 may include recess 116. Controller 140, batteries 160 may be located in recess 116. Batteries 160 may be connected to controller 140 with wires 142. Similarly, PV module 130 may be connected to controller 140 with wires 132 and lights 150 may be connected to controller 140 with wires 154. Once the various components are in place, recess 116 may be filled with a hardening filler 170 such as epoxy to hold the various components in place and protect marker light 100 from weather.

Controller 140 may control the energy collection of PV module 130, the energy storage in batteries 160, and the operation of lights 150. In some embodiments, controller 140 may restrict energy flow from PV module 130 once batteries 160 are at capacity to avoid damage to batteries 160. Controller 140 may also control the output of lights 150. For example, controller 140 may output energy from batteries 160 to lights 150 only when PV module 130 is not collecting energy, or is collecting energy below a certain threshold. Lights 150 may flash at an interval determined by controller 140, or may have a solid, continuous output.

Lights 150 may be LEDs. Lights 150 may be located on housing 110 in a location to provide visibility of lights 150 from the desired roadway or location. In FIG. 1, lights 150 are located on the sides of housing 110 and slightly angled to project light emitted from lights 150 down a roadway. Lights 150 may be placed as desired for the particular application. For example, in some embodiments, lights 150 may be located on the top, or on the sides with various angles depending on the desired usage. In some embodiments, the angle may be determined based on the curvature of the roadway or perpendicular to each other on an intersection.

In some embodiments, lights 150 may be of different colors, depending on the intended placement or use of marker 100. For example, lights 150 on a divided highway may be orange (amber) on one side and white on the other to indicate the sides of the roadway, similar to reflective markers used on highways. In other uses, lights 150 may be blue to mark a hospital route, or as placements on a helicopter landing pad. Lights may also be red to warn of a stop signal or sign. Lights 150 may be any color desired, depending on the desired use. In some embodiments, Lights 150 may be multi-colored LEDs that may output different colors as determined by the controller and the particular situation required. For example, lights 150 may alternate different colors, such as red and amber to warn of a particular danger.

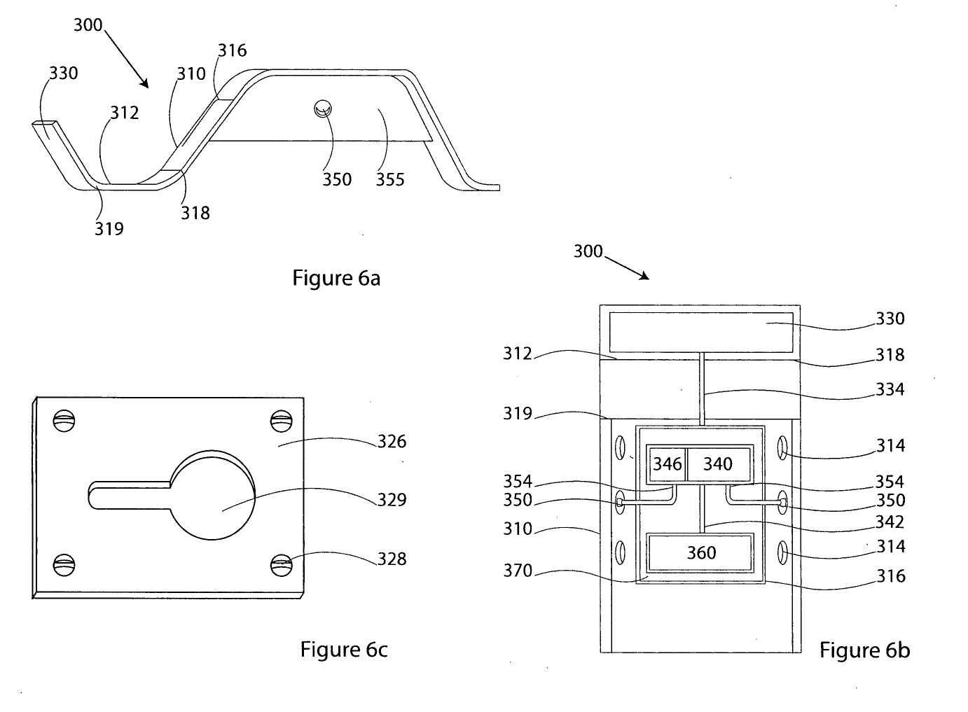

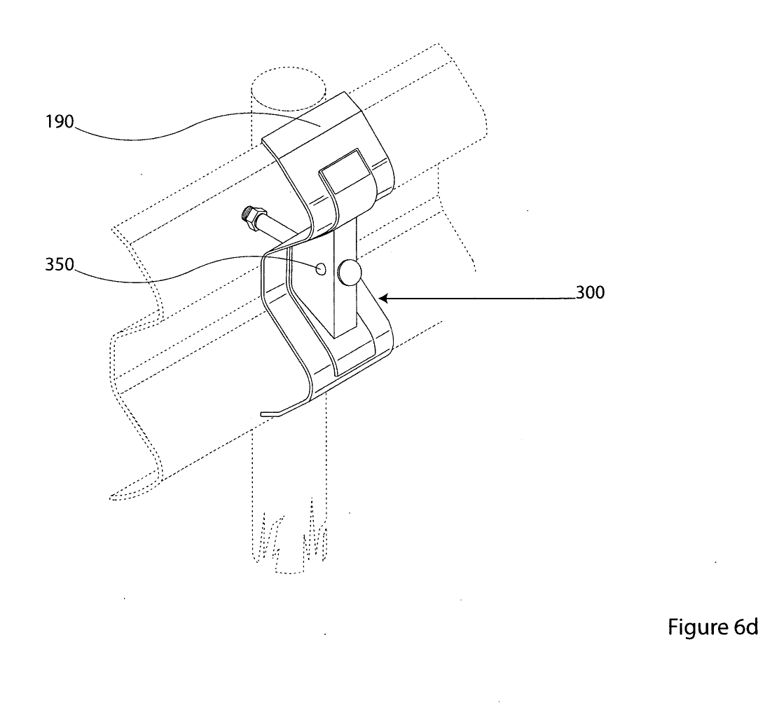

Batteries 160 may be one or more rechargeable batteries or capacitors. Batteries 160 may be lithium ion batteries, nickel cadmium, or any other rechargeable batteries suitable for use in a solar powered marker light. The type of batteries 160 may be selected based on the anticipated service life, service location, price, or any combination of these factors, and including other factors as desired. In some embodiments, marker 100 may have a life-cycle of several years. Similarly, as shown further in FIG. 6b, batteries 160 may be replaceable once the useful life of batteries 160 is reached through a sealable access to the battery compartment in housing 110.

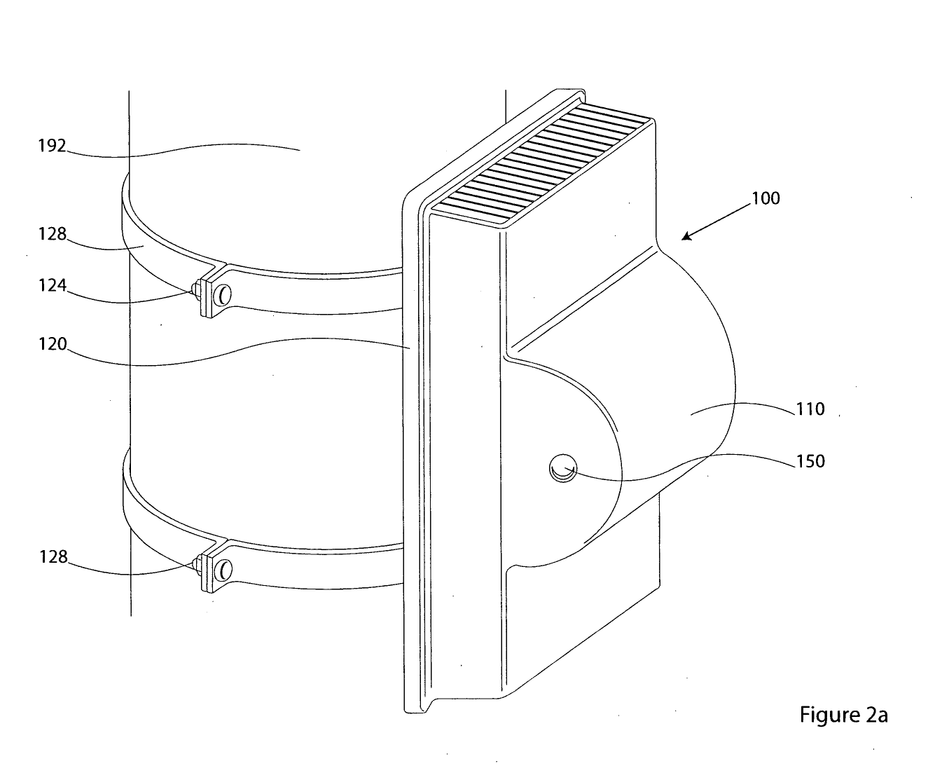

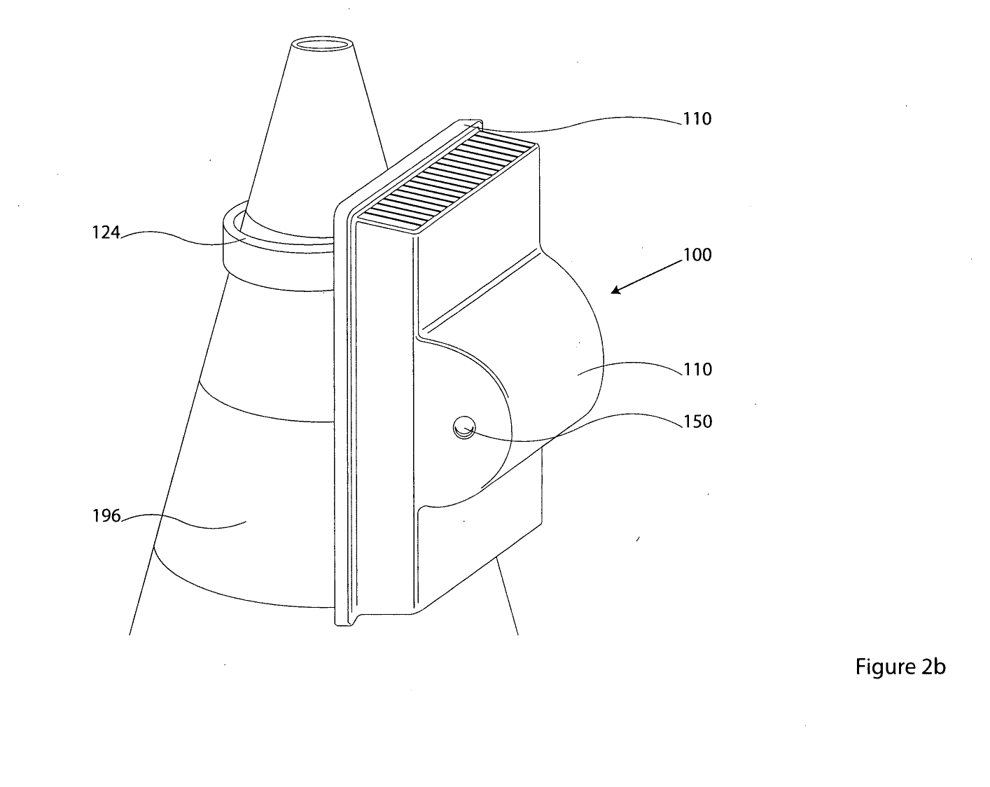

FIG. 2a illustrates marker 100 with plate 120 attached to housing 110. Plate 120 may include connectors 124 for coupling marker 100 to a pole 192 or to a barrel, or to anything cylindrical, such as a tree. Connectors 124 may include couplers 128 to tighten connectors 124 to pole 192. FIG. 2b illustrates a similar plate 120 on marker 100. Plate 120 includes only a single connector 124 that may be placed over cone 196 for a temporary lighted barrier.

Connectors may be integrally formed with plate 120, or may be affixed with glue, fasteners, or any other desired method. Similarly, connector 124 may be made of a different material than plate 120. Plate 120 may also be made of a different material than housing 110. For example, housing 110 may be made of plastic and plate 120 may be made of metal. Each component may be made of any suitable material, depending on the application.

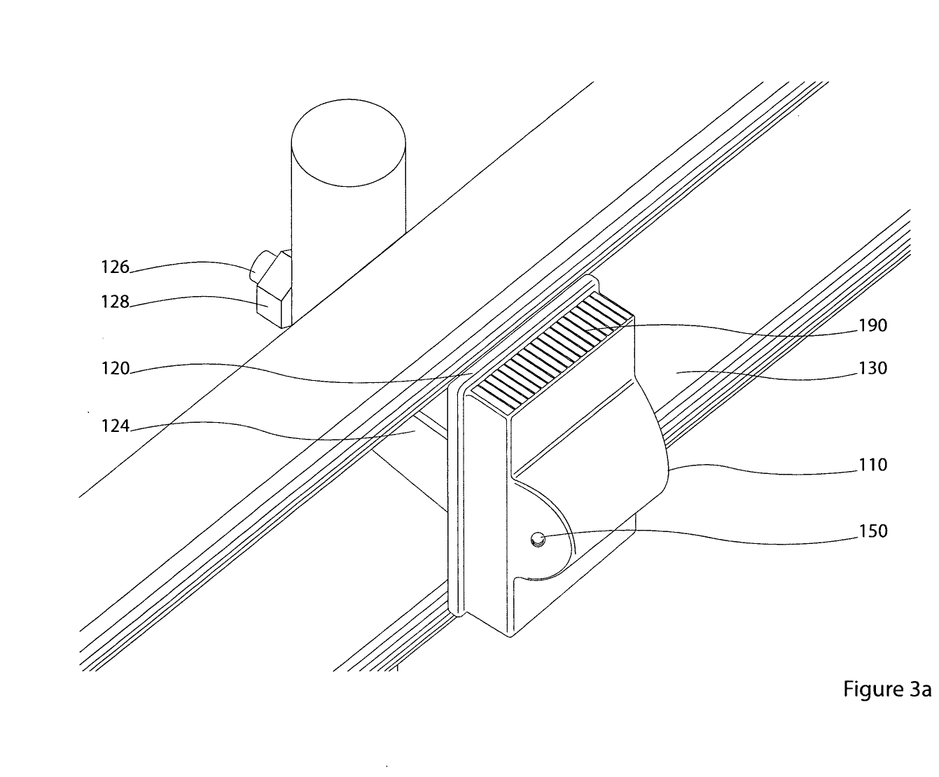

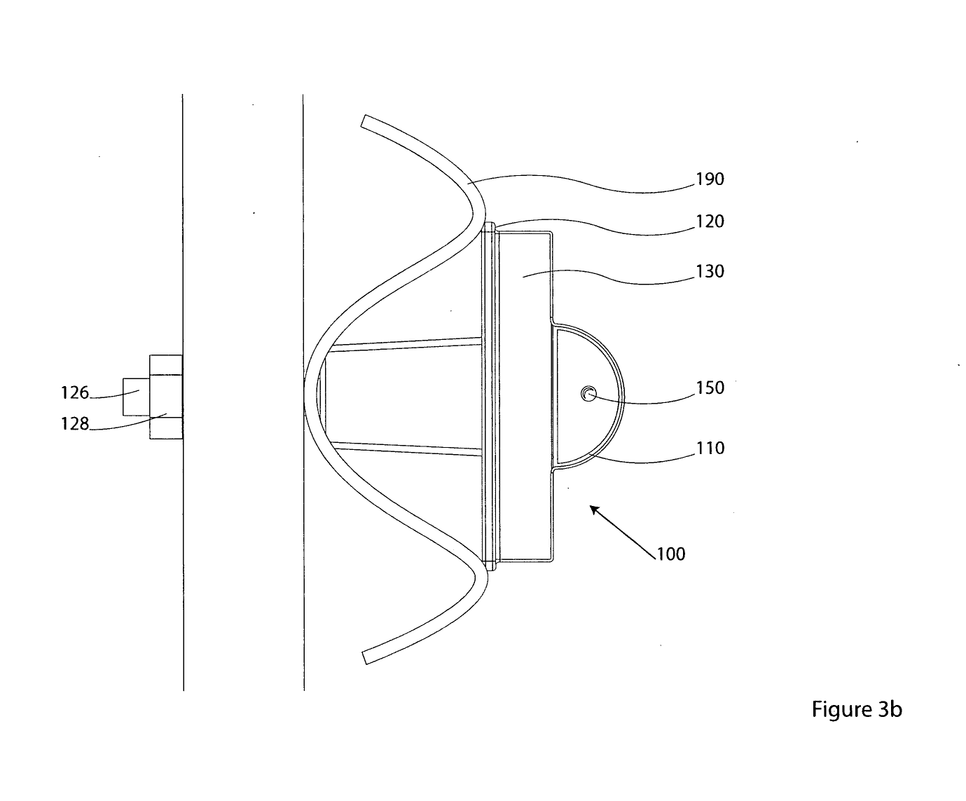

FIGS. 3a and 3b illustrate housing 110 of marker 100 installed on steel corrugated barrier 190. Plate 120 includes connector 124 that extends into the recess of barrier 190, along with coupler 128 on shaft 126. Coupler 128 and shaft 126 may be complimentary bolt and nut, or other fasteners that is sufficient to connect marker 100 to the desired surface, barrier, or object. In some embodiments, coupler 128 and shaft 126 may replace the fasteners used to hold barrier 190 to a supporting post.

FIG. 4 illustrates marker 100 attached to barrier 194. In such embodiments, plate 120 may be attached to barrier 194 with glue, or with other fasteners. Similarly, in some embodiments, housing 110 may snap onto plate 120, allowing plate 120 to be first connected to barrier 194 and then housing 110 being connected to plate 120.

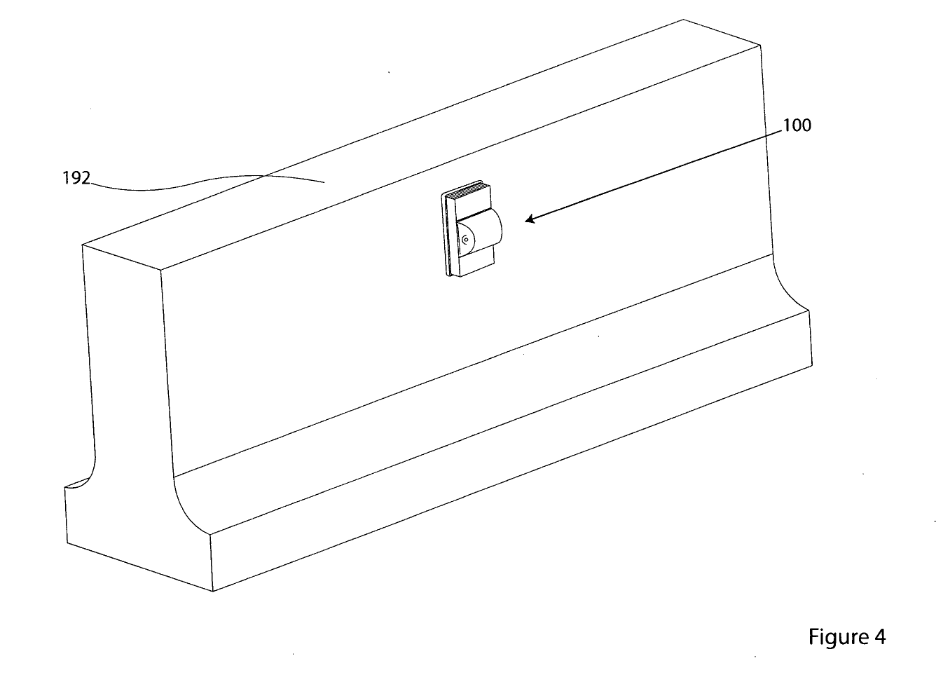

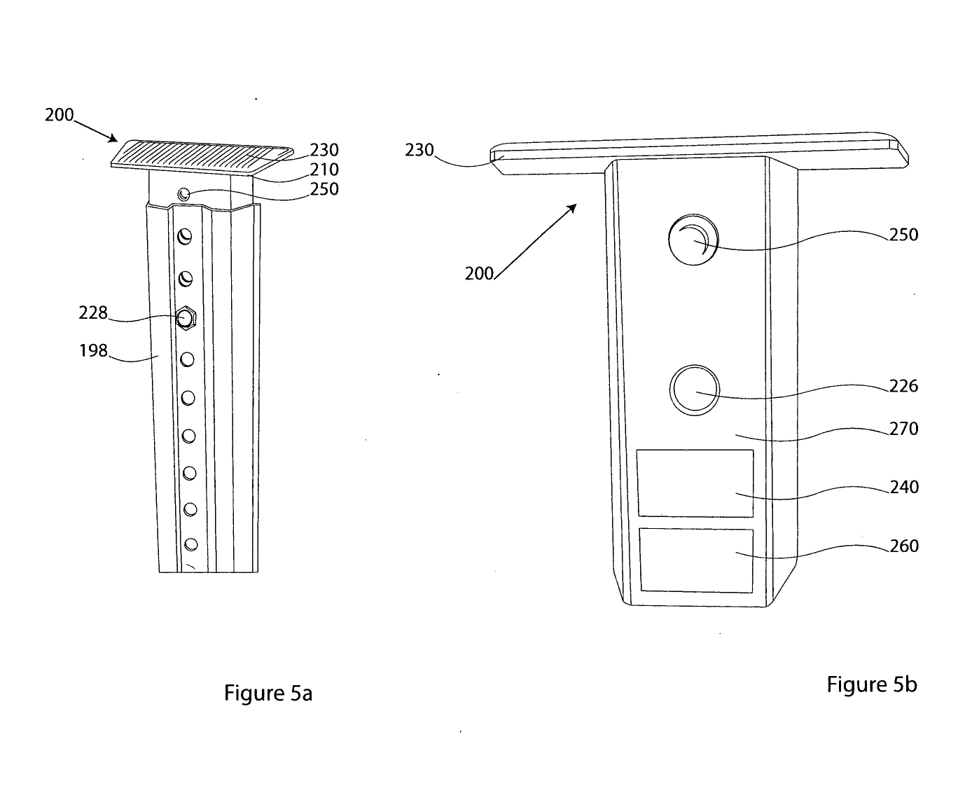

FIGS. 5a and 5b illustrate marker 200 for placement in roadside marker posts 198. Marker 200 may include components similar to marker 100, such as PV module 230, controller 240, light 250, and batteries 260. Housing 210 may be formed with a shape that may conform to the general “U” shape of roadside marker posts 198. Housing 210 may be formed with an open front or back for placement of the internal components and then filled with epoxy 270 or another solid filler material to protect marker 200 from weather. In some embodiments, the portion of housing 210 holding batteries 260 may be accessible through a sealable access door.

Fastener 226 may be implanted in epoxy 270, or may be part of housing 210. Fastener 226 and light 250 may be spaced to correspond to the existing spaced openings in post 198 used to connect various signs, reflectors, etc. Thus, marker 200 may be almost entirely within post 198 on three sides with PV module 230 on top to collect solar energy.

Marker 300 shown in FIGS. 6a, 6b, and 6d may be formed to correspond to the shape of barrier 190 shown in FIGS. 3a, 3b, and 6d. Similar to marker 200, marker 300 includes the same basic components as marker 100. Marker 300 includes housing 310, PV module 330, controller 340 and batteries 350. Recess 316 of housing 310 may be filled with epoxy 370, or may be covered by a door 370 for access to change batteries 350 when they reach their useful life.

Housing 310 may be formed with a shape to correspond to barrier 190 including flat 312 and bends 318 and 319. In some embodiments, bends 318 and 319 may be formed such that they are flexible or hinged to allow for forming to different sizes or locations of barrier 190. Housing 310 may also include fastener posts 314 to correspond to plate 326 shown in FIG. 6c.

Marker 300 may also include reflectors 355 in addition to lights 350. The various components may be connected with wires 334, 354, and 342, similar to marker 100. In some embodiments marker 300, or any other marker configuration, may include magnetic switch 346 that may allow marker 300 to be shipped in an off position, even though the inside of the container is dark, which would otherwise cause controller 340 to activate lights 350.

Plate 326 may be attached to marker 300 to allow attachment to barrier 190 using the connector bolts on barrier 190. The connector bolt may be loosened and then the head of the bolt slipped through opening 329 and slid over such that when the bolt is tightened, marker 300 is affixed to barrier 190. Plate 326 may be attached to posts 314 of housing 310 through holes 328.

Each feature shown and described in the various embodiments and configurations may be used on other embodiments and configurations, as desired and appropriate. The embodiments and configurations illustrated and described are exemplary of the features of the invention as defined by the appended claims. The claims are not limited by only what is described in this disclosure, as the principals and features of the invention may be incorporated in various embodiments anticipated by this disclosure.

What is claimed is:

1. A solar-powered marker, comprising:
a housing;
a controller located in the housing;
a PV module located on the housing and operatively coupled to the controller;
at least one energy storage element operatively coupled to the controller; and
at least one light coupled to the housing.

2. The marker of claim 1, wherein the controller is configured to control the at least one light only when the PV module is collecting less than a threshold amount of energy.

3. The marker of claim 2, wherein the threshold amount of energy corresponds to the amount of energy collected at about dusk.

4. The marker of claim 1, wherein the controller is configured to control the at least one light in a flashing output.

5. The marker of claim 1, wherein the at least one light is a blue light, and wherein the marker is configured to be used to mark at least one of a hospital location, or a landing pad for a helicopter.

6. The marker of claim 1, further comprising a connector configured to couple the marker to an object.

7. The marker of claim 6, wherein the object is at least one of a corrugated traffic barrier, a concrete traffic barrier, a traffic barrel, a marker post, a cone, a tree, a gate, a fence, and a concrete pad.

8. The marker of claim 1, further comprising a magnet switch configured such that a magnet placed in proximity to the switch prevents the controller from operating the at least one light.

9. The marker of claim 1, wherein the at least one energy storage element is replaceable.

10. The marker of claim 1, wherein the controller and the at least one storage element are encased in epoxy and permanently attached to the housing with the epoxy.

11. The marker of claim 1, wherein the at least one light is an LED.

12. The marker of claim 11, wherein the at least one light includes at least two LEDs.

13. The marker of claim 1, further comprising reflector tape.

14. The marker of claim 1, wherein the housing is configured to be adjusted to accommodate the shape of a traffic barrier.

15. The marker of claim 14, wherein the marker is configured to be attached to the traffic barrier using a existing fastener on the barrier.

16. The marker of claim 1, wherein he controller is configured to continuously output energy to the at least one light during low visibility.

17. The marker of claim 1, wherein the at least one light is a multi-color LED and wherein the controller is configured to control output of the LED of different colors at different times.

18. The marker of claim 1, wherein the housing includes a sealable access and wherein at least one energy storage element is replaceable through the access.

19. The marker of claim 1, wherein the housing is configured to conform to the shape of a roadside object.
